(19) United States
(12) Patent Application Publication
(10) Pub. No.: US 2006/0001221 A1
(43) Pub. Date: Jan. 5, 2006

(54) Gasket seal

(76) Inventors: Eric Herrera, Lincoln City, OR (US); Matthew Brian Chapman, Linden, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(21) Appl. No.: 10/880,678

(22) Filed: Jun. 30, 2004

(51) Int. Cl. F02F 11/00

(52) U.S. Cl. 277/592

(57) ABSTRACT

A gasket for use in sealing a first component to a second component includes a first portion having a first shape factor. The first portion is adapted to seal the first component to the second component. A second portion has a second shape factor, the second portion is adapted to minimize vibration transmission between the first and second components. The first shape factor is designed to maximize sealability of the first portion and the second shape factor is designed to minimize vibration transmission of the second portion.

### FIELD OF THE INVENTION

The present invention relates to gaskets, and more particularly to a gasket seal having improved noise, vibration, and handling characteristics.

### BACKGROUND OF THE INVENTION

Gaskets are used in a wide variety of applications to form a seal between two matched parts. Typically, a bead arrangement is formed on a portion of the gasket that elastically deflects when compressed. The internal spring force within the bead under elastic compression provides a seal between the parts.

Perimeter gaskets are defined by a bead arrangement that is designed to encircle the area to be sealed between the matched components. Typically, the matched components are coupled together, with the perimeter seal therebetween, using conventional bolts. These bolts extend through bolt holes formed in the matched components.

The purpose of the gasket is to seal the two components together and therefore sealing forces must be maintained on the bead in order to maintain the internal spring force, and hence the seal. In this regard, conventional gaskets have been designed to elastically deflect sufficiently to maintain this seal.

While these conventional gaskets are useful for their intended purpose, there is room in the art for improvement. Specifically, noise, vibration, and handling characteristics (NVH) of one matched component are often transferred directly through the gasket onto the matching part and gasket through the bolts. In the case of an automobile, for example, this NVH can be highly undesirable.

Accordingly, the present invention provides the art with a gasket having a bead arrangement that reduces NVH transmitted through the gasket without substantially increasing manufacturing costs and without diverting sealing loads.

### SUMMARY OF THE INVENTION

A gasket for use in sealing a first component to a second component includes a first portion having a first shape factor. The first portion is adapted to seal the first component to the second component. A second portion has a second shape factor, the second portion is adapted to minimize vibration transmission between the first and second components. The first shape factor is designed to maximize sealability of the first portion and the second shape factor is designed to minimize vibration transmission of the second portion.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a bottom view of an exemplary cam cover and a gasket constructed according to the principles of the present invention;

FIG. 2 is an enlarged view of the exemplary cam cover and gasket of the area enclosed by circle 2-2 in FIG. 1;

FIG. 3 is a cross-sectional view of a portion of the gasket of the present invention viewed in the direction of arrow 3-3 in FIG. 2; and

FIG. 4 is a cross-sectional view of a portion of the gasket of the present invention viewed in the direction of arrow 4-4 in FIG. 2.

### DETAILED DESCRIPTION OF THE PREFERRED EMBODIMENTS

The following description of the preferred embodiment(s) is merely exemplary in nature and is in no way intended to limit the invention, its application, or uses.

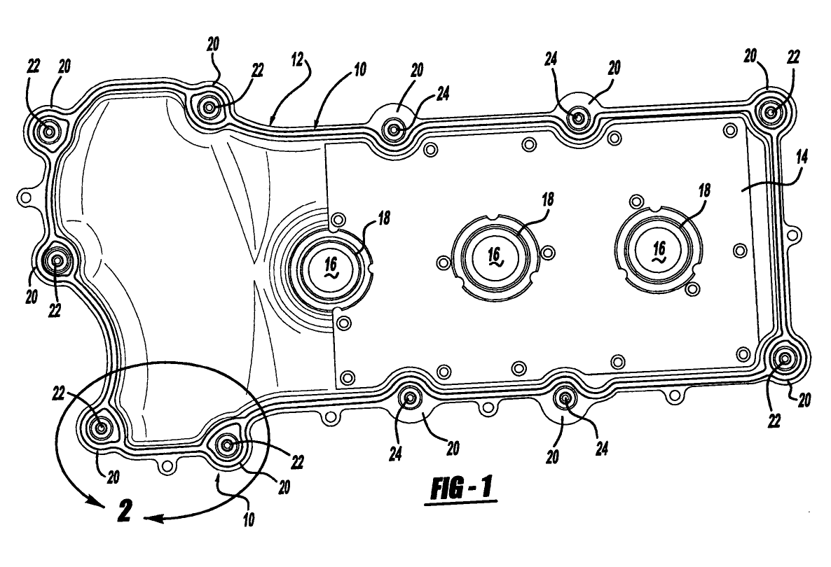

With reference to FIG. 1, a gasket 10 constructed according to the principles of the present invention is shown in operative association with an exemplary cam cover 12. The gasket 10 is a perimeter gasket and is operable to seal the cam cover 12 to a cylinder head (not shown). However, it should be appreciated that the gasket 10 may be of any type and may be used to seal any first component to any second component. Accordingly, the shape and size of the gasket 10 are defined by the requirements of providing an effective seal between these components. It should be appreciated, therefore, that the shape and design of the gasket 10 illustrated in the present invention is not limited to the particular arrangement illustrated in FIG. 1.

The cam cover 12 generally includes a body 14 having a plurality of cylinder head apertures 16 formed therethrough. Each cylinder head aperture 16 is adapted to align and couple with the cylinder head (not shown) of an engine (not shown). The cylinder head apertures 16 are circumferentially surrounded by a bead 18. The bead 18 is operable to seal the gasket 12 to the cylinder head.

The body 14 of the cam cover 12 further includes a plurality of flange portions 20 that extend out from the body 14. The flange portions 20 are formed along the perimeter of the cam cover 12. Each flange portion 20 includes a bolt hole formed therethrough, including corner bolt holes 22 and body bolt holes 24. The corner bolt holes 22 are positioned along the perimeter through a flange portion 20 wherever there is a corner formed in the body 14. In the particular example provided, the cam cover 12 includes seven corner bolt holes 22. The plurality of body bolt holes 24 are also along the perimeter of the cam cover 12 through a flange portion 20. The body bolt holes 24 are positioned along straight sections of the perimeter of the cam cover 12. In the particular example provided, the cam cover 12 includes four body bolt holes 24.

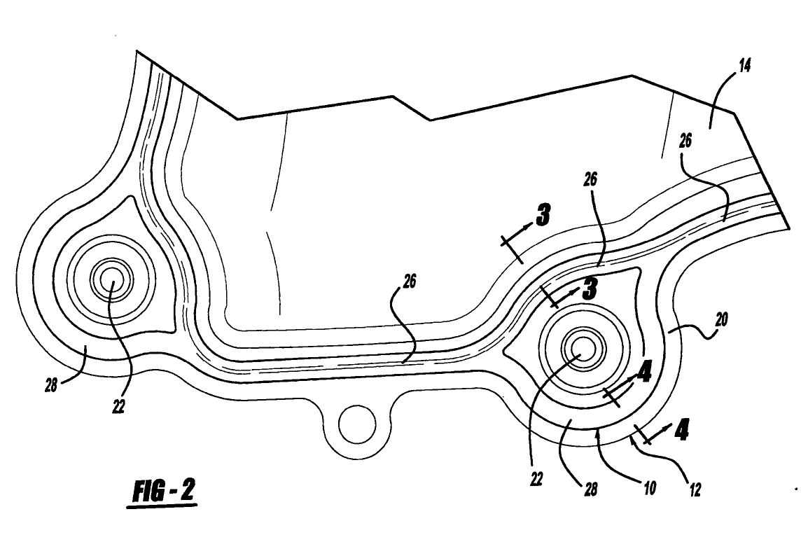

Turning now to FIG. 2, the gasket 10 will be described in further detail. As noted above, in the particular example provided the gasket 10 is a perimeter gasket sized to extend along the perimeter of the cam cover 12. The gasket 10 generally includes a perimeter bead portion 26 and a reinforcement bead portion 28.

With reference to FIG. 3, the perimeter bead portion 26 has a generally rectangular shaped body portion 30 with an enlarged truncated triangular head 32 extending therefrom. A pair of ribs 34 are formed on opposite sides of the perimeter bead portion 26, i.e., a pair of ribs 34 are formed on an end of the rectangular body 30 and on an end of the truncated triangular head 32. The ribs 34 deflect when the gasket 10 is compressed between the cam cover 12 and the cylinder head (not shown). The ribs 34 retain an internal spring force upon deflection that acts to seal the perimeter bead portion 26 to the two components. In this regard, the perimeter bead portion 26 is designed to maximize the seal between these two components. Returning to FIG. 2, the perimeter bead portion 26 extends around a portion of the flange portion 20 and around a portion of the bolt holes 22, 24. In the example provided, the perimeter bead portion 26 extends around a portion of the bolt holes 22, 24 inwardly from the bolt holes 22, 24 (i.e., on the side of the bolt holes 22, 24 towards the center of the cam cover 12).

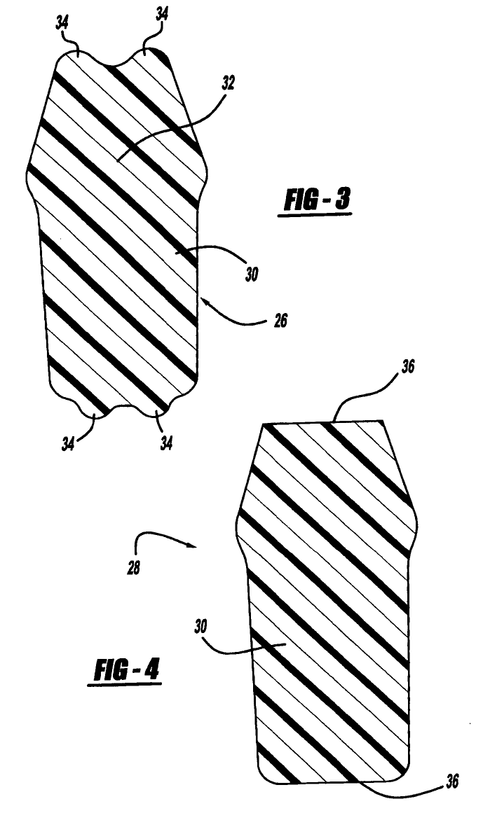

With reference to FIG. 4, the reinforcement bead portion 28 is designed to reduce the NVH transmitted through bolts (not shown) that couple the cam cover 12 (FIGS. 1 and 2) to the cylinder head (not shown). The actual shape and design of the reinforcement bead portion 28 will be, therefore, dependent on the specific environment to which it is applied. In the particular example provided, the reinforcement bead portion 28 includes a similar cross section to that of the perimeter bead portion 26 in FIG. 3, however, the reinforcement bead portion 28 does not include the ribs 34. Instead, the reinforcement portion 28 includes flat surfaces 36 on opposite sides thereof. In this regard, under an identical compression load, the reinforcement bead portion 28 is compressed less than the perimeter bead portion 26. For any given application, the shape of the reinforcement bead portion 28 will be largely defined by its shape factor (i.e. its ratio of surface area under compression to surface area not under compression). The shape factor will be tuned to minimize the NVH transmission between any two components, or multiple components, that will compress the gasket 10 when in use. In this regard, the bead portions 26, 28 may be tuned to their respective tasks separately (i.e., the perimeter bead portion 26 tuned for maximum sealing, the reinforcement bead portion 28 tuned for maximum NVH transmission prevention).

Returning to FIG. 2, the reinforcement bead portion 28 extends out from the perimeter bead portion 26 in a loop to surround any given bolt hole 22, 24. In the particular example provided, the reinforcement bead portion 28 extends around the corner bolt holes 22 supported by the flange portion 20 and intersects the perimeter bead portion 26 at an opposite end thereof. Preferably, the perimeter bead portion 26 and reinforcement bead portion 28 are formed from a single unitary material.

The gasket 10 reduces NVH transmission by controlling the flange portions 20 which may or may not include stiffening the flange portions 20 surrounding the bolt holes 22, 24 to thereby lessen vibration transmission. As noted above, the gasket 10 provides dual functions by effectively sealing the two components together using the perimeter bead portion 26 while reducing NVH transmission using the reinforcement bead portion 28. Added benefit is achieved by employing substantially similar cross sectional areas within the gasket 10, thereby limiting any increases to manufacturing costs.

The description of the invention is merely exemplary in nature and, thus, variations that do not depart from the gist of the invention are intended to be within the scope of the invention. Such variations are not to be regarded as a departure from the spirit and scope of the invention.

1. A gasket for use in sealing a first component to a second component comprising:
a first portion having a first shape factor, the first portion adapted to seal the first component to the second component; and
a second portion having a second shape factor, the second portion adapted to minimize vibration transmission between the first and second components;
wherein the first shape factor is designed to maximize sealability of the first portion and the second shape factor is designed to minimize vibration transmission of the second portion, said gasket being formed entirely from a single unitary material.

2. (canceled)

3. The gasket of claim 1, wherein the first portion includes a pair of ribs formed on opposite sides thereof.

4. The gasket of claim 1, wherein the first portion is adapted to surround a perimeter of the first component.

5. The gasket of claim 1, wherein the second portion extends out from the first portion in a loop, the loop adapted to at least partially surround a bolt hole formed in the first component.

6. The gasket of claim 1, wherein the first shape factor is different than the second shape factor.

7. A sealing arrangement comprising:
a first component having at least one bolt hole formed therein; and
a gasket having a first portion extending around a perimeter of the first component and having a second portion at least partially extending around the bolt hole, said gasket being formed entirely from a single unitary material;
wherein the first portion is designed to seal to the first component and the second portion is designed to minimize vibration transmission near the bolt hole.

8. The gasket of claim 7, wherein the first and second portions cooperate to surround the bolt hole.

9. The gasket of claim 7, wherein the first component further includes a flange portion extending therefrom with the bolt hole formed therein, the second portion extending from the first portion onto the flange portion and surrounding at least a portion of the bolt hole.

10. The gasket of claim 7, wherein the second portion has flat surfaces formed on opposite sides thereof.

11. The gasket of claim 10, wherein the first portion includes a pair of ribs adapted to seal to the first component when compressed.

12. The gasket of claim 7, wherein the first component is shaped to include a corner and a straight portion, the corner including a first bolt hole formed therein and the straight portion including a second bolt hole formed therein, the second portion extending around at least a portion of the first bolt hole.

13-18. (canceled)
